(19) United States
(12) Patent Application Publication
(10) Pub. No.: US 2017/0124582 A1
(43) Pub. Date: May 4, 2017

(54) METHODS AND SYSTEMS FOR ADJUSTING OBLIGATIONS IN OUTSOURCING CONTRACTS

(71) Applicant: EVEREST GLOBAL, INC., Dallas, TX (US)

(72) Inventors: Peter Bendor-Samuel, Dallas, TX (US); Marvin Newell, Dallas, TX (US)

(21) Appl. No.: 14/713,078

(22) Filed: May 15, 2015

(51) Int. Cl. G06Q 30/02; G06Q 40/04

(52) U.S. Cl. CPC G06Q 30/0206; G06Q 40/04

(57) ABSTRACT

The present invention provides systems and methods for determining appropriate economic adjustments during the term of an outsourcing agreement or in conjunction with other foreign business operations. These economic adjustments are useful in maintaining the economic balance between a buyer and a vendor over the life of the outsourcing agreement and/or the domestic and global business operations to which the methods are applied.

### TECHNICAL FIELD

The present invention is in the field of outsourcing agreements and foreign business operations. In particular, the present invention provides systems and methods for determining appropriate economic adjustments during the term of an outsourcing agreement or in conjunction with other foreign business operations. These economic adjustments are useful in maintaining the economic balance between a buyer and a vendor over the life of the outsourcing agreement and/or the domestic and global business operations.

### BACKGROUND OF THE INVENTION

Many businesses and organizations have found advantages in outsourcing one or more of their functions or services to a third party vendor. These outsourcing agreements can allow a business to focus on its core competencies while mitigating a shortage of skill, expertise or available employees, particularly in ancillary or support functions. Outsourcing can also offer greater budget flexibility and control by letting a business pay for only the services it needs, when it needs them.

When properly configured and utilized, outsourcing agreements can provide businesses with a competitive advantage associated with, for example, reduced cost structures, ready access to more workers with a specific skill set, improved efficiencies, improved revenue realization and/or ROI. Depending on the location and the services provided, however, some outsourcing agreements can lead to complications that can include, for example, reduced control of business processes, quality and production issues, increased susceptibility to natural disasters or civil unrest, language and/or cultural barriers.

Accordingly, any outsourcing agreement should include careful consideration of both the potential vendor and the outsourcing location. Particularly for companies with little experience in outsourcing, an outsourcing consultant can be invaluable for assisting such companies in evaluating, structuring and implementing sourcing solutions. The methods and systems below improve the ability to analyze, compare and/or adjust outsourcing agreements based on numerous factors that can affect the outsourced functions.

### BRIEF DESCRIPTION OF THE INVENTION

The outsourcing industry has been in constant evolution since its inception. For a buyer who has committed to an outsourcing agreement with one or more vendors, particularly an agreement spanning several years or more, it is important to “lock in” the economics of the agreement. Preserving the economic balance defined by the particular agreement in light of changing conditions ensures that the buyer does not end up overpaying for the contracted goods and/or services in later years.

While the detailed description below focusses on outsourcing agreements for convenience, the methods and systems described are not so limited. Indeed, the novel methods and systems described herein may be used for evaluating and adjusting the economics of a wide range of global business agreements including, for example, the operation of global in-house centers (GICs), the operation of foreign subsidiaries, joint ventures and/or the operation of foreign partners.

Perhaps just as importantly, by allowing the parties to preserve the economic relationship defined by the particular agreement the method protects the vendor from being substantially underpaid and reduces the likelihood of diminished services and/or quality over the life of the agreement. The disclosed method provides for the incremental adjustment of the economic balance over the life of the agreement. By incorporating the disclosed method for periodically adjusting the economic balance, both the buyer and the vendor can maintain their bargained for positions in both cost and services from these relationships in the face of changing economic conditions.

The method incorporates data relating to a number of contract-specific parameters that may include, for example, the exchange rates for the associated currencies, the labor structure for servicing the contract, the employee expertise tiers for servicing the contract, the wage tiers associated with both the contracting location and the particular skills required. Other considerations may include parameters including, for example, employee turnover, the competitive environment in the contracting location and/or the broader economic and/or political issues in the contracting location.

The effectiveness of the method is, therefore, dependent on the quality of the specialized parametric information available in a database for accurately benchmarking the specific contracting location and job functions being considered in connection with a particular contact or RFQ. This benchmarking activity helps align a company's information technology outsourcing (ITO) and/or business practice outsourcing BPO pricing with global market standards. The benchmarking function can be approached as an input-based and output-based.

Therefore, it is an object of the present invention to determine and to increase the accuracy of the costing of an outsourcing agreement comprising a plurality of contract-specific parameters.

This object is achieved using a computer implemented method in which, after identifying a number of contract-specific parameters, can be used for costing projections associated with each contract-specific parameter wherein the costing depends, in turn, on a number of other factors or variables specific to the parameter in question. Depending on the type of data available, the costing of each of the contract-specific parameters may be assigned an accuracy value that can be used for producing a weighted total value.

In accordance with another embodiment of the present invention, a computer readable medium containing a program of instructions executable by a computer to perform a method for increasing the accuracy of a cost projection for one or more outsourcing agreements in which the total cost is a function of a number of contract-specific parameters, which depend, in turn, on a number of other factors or variables specific to the parameter in question. The computer readable medium may include instructions for assigning an accuracy value for the cost determined for each contract-specific parameter in order to provide a weighted estimate for one or more of the parameters that can be used for evaluating the overall accuracy of the cost estimate for the particular outsourcing agreement.

These and other objects and novel features of the invention will be more fully apparent when the description of the following exemplary embodiments are read in conjunction with the accompanying drawings and claims. The drawings provided herewith are intended to be illustrative only and are not intended to limit unduly the scope of this invention as defined by the claims.

### BRIEF DESCRIPTION OF THE DRAWINGS

FIG. 1 illustrates the basic methodology that can be applied to each location, service and/or vendor relevant to a particular outsourcing agreement, whether existing or proposed;

FIG. 2 illustrates application of the basic methodology to a single factor, i.e., wages, that could, in turn, be applied to each relevant factor in a particular outsourcing agreement; and

FIG. 3 illustrates application of the basic methodology to a wage pyramid by which shifts in the distribution of human resources within the various worker categories can be utilized in evaluating and, as necessary, correcting an outsourcing agreement.

### DETAILED DESCRIPTION OF THE INVENTION

The outsourcing industry has been in constant evolution since its inception. For a buyer who has committed to an outsourcing agreement with one or more vendors, particularly an agreement spanning several years or more, it is important to “lock in” the economics of the agreement. Preserving the economic balance defined by the particular agreement in light of changing conditions ensures that the buyer does not end up overpaying for the contracted goods and/or services in later years.

While the detailed description below focusses on outsourcing agreements for convenience, the methods and systems described are not so limited. Indeed, the novel methods and systems described herein may be used for evaluating and adjusting the economics of a wide range of global business agreements including, for example, the operation of global in-house centers (GICs), the operation of foreign subsidiaries, joint ventures and/or the operation of foreign partners.

Perhaps just as importantly, by allowing the parties to preserve the economic relationship defined by the particular agreement the method protects the vendor from being substantially underpaid and reduces the likelihood of diminished services and/or quality over the life of the agreement. The disclosed method provides for the incremental adjustment of the economic balance over the life of the agreement. By incorporating the disclosed method for periodically adjusting the economic balance, both the buyer and the vendor can maintain their bargained for positions in both cost and services from these relationships in the face of changing economic conditions.

The method incorporates data relating to a number of contract-specific parameters that may include, for example, the exchange rates for the associated currencies, the labor structure for servicing the contract, the employee expertise tiers assigned for servicing the contract, the wage tiers associated with both the contracting location and the particular skills required for each of the employee expertise tiers, etc. Other considerations may include parameters including, for example, employee turnover, the current and/or projected competitive environment in the contracting location and/or the broader economic and/or political issues in the contracting location.

The effectiveness of the method depends, therefore, on the quality of the specialized parametric information available in a database for accurately benchmarking the specific contracting location and job functions being considered in connection with a particular contact or RFQ. This benchmarking activity helps align a company's information technology outsourcing (ITO) and/or business practice outsourcing BPO pricing with global market standards. The benchmarking function can be approached as an input-based and output-based process depending on the nature of, source of, volume of, history of, and confidence in the parametric information available.

Input-based benchmarking provides a buyer with comparative pricing data broken down by both resource skill(s) and other pricing drivers associated with the particular deal environment. A typical input-based benchmarking report will include information for analyzing the equivalent market price including, for example, 20^{th} percentile, 80^{th} percentiles and the median values of the target market range.

Conversely, output-based benchmarking provides a buyer with the comparative pricing data by resource unit for each ITO tower or BPO process and an understanding of the pricing drivers associated with the particular deal environment. A typical output-based benchmarking report will, therefore, focus on primary drivers of output-based pricing at the resource unit level for each target technology (e.g., price per server) or business process (e.g., price per invoice).

When the particular outsourcing solution is sufficiently well defined, the targeted economic databases can also be used for identifying potential and/or preferred deal environments. When sufficient information is not available for a particular inquiry, the available financial information for similar rates and skills in other geographies can be “triangulated” to provide a reasonable estimate of the corresponding values in the target location(s).

As companies expand their leverage of global services, the landscape of service delivery locations continues to expand. Accordingly, identifying the most appropriate location(s) and vendors for implementing an outsourcing agreement is becoming more critical. Everest Group, for example, tracks more than 150 locations across North America, Central and South America, Continental Europe, Central and Eastern Europe, South and Southeast Asia, and Australasia. This tracking focusses on, for example, the evolution of cost structures and skill pools associated with key labor functions in each of the monitored cities and/or regions. In addition to the cost structures and skill pools, the database may also include, for example, information relating to market activity, the stability of the environment and impending regulatory issues.

This information can, in turn, be used for analyzing a variety of location decisions including, for example, identifying roles for locations in the outsourcing portfolio, guiding service(s) distribution; monitoring and adjusting for changing cost structures, monitoring emerging risks for balancing financial benefit and risk mitigation.

The location identification may, in turn, include selecting among potential locations for those that can provide the desired scale, financial and risk objectives for specific talent pools ranging from basic transaction processing skills to sophisticated industry-specific domain skills.

Monitoring emerging risks may include, for example, monitoring natural, economic and political risks. Depending on the location, the monitored risks may include attrition, inflation, talent pool saturation, pandemic threats, weather threats, and macro-economic and/or geo-political concerns.

Foreign exchange risk is inherent in contracts in which the vendor incurs performance costs in one country but is paid in the currency of another country. For example, in a typical offshore outsourcing agreement, the vendor lease spaces, hires personnel and pays for other resources in the local currency, but may receive payment for services rendered in U.S. dollars. Accordingly, when the dollar weakens relative to the local currency, the contracted payment in U.S. dollars, may be insufficient to cover the vendor's obligations in the local currency. Conversely, when the dollar strengthens relative to the local currency, the contracted payment will be in excess of the amount necessary in the local currency and can present a windfall to the vendor.

The allocation of the parties' respective risk for foreign exchange rate fluctuations is often addressed in combination with a second variable cost element, inflation. Inflation is a somewhat loose term that can be based on a number of different Price Indices including, for example:
Consumer Price Index (CPI)—a measure of the price of a selection of goods and services for a typical consumer;
Commodity Price Index—a weighted measure of the price of a selection of commodities;
Cost of Living Index (COLI)—a measure of the cost to maintain a constant standard of living.
Producer Price Index (PPI) (or Wholesale Price Index (WPI))—a measure of the prices for all goods and services at the wholesale level.
GDP Deflator—a measure of the prices of all goods and services (GDP) within a defined jurisdiction.

In certain locations, Venezuela for example, inflation (reported as over 55% in 2013) is currently running well above the world average (about 3.5%) and would, therefore, constitute a substantial variable in any long-term agreement with a Venezuelan vendor. As noted above, the basic inflation numbers tend to be derived from a number of factors that may not be particularly relevant to the target labor marker in particular location.

Accordingly, although the disclosed methods can consider general “inflation” as a factor, it is maintained that more accurate adjustments are preferably weighted toward the wage tier data associated with specific skill sets. The more narrow focused business-specific data will provide a more accurate assessment of the true value of the contracted labor and/or services in the target location.

The disclosed methods are preferably implemented on a computer-based system that provides access to a range of location-specific and general databases containing detailed current and historical information for parameters including, for example, wage tier data, labor skill tier data, real estate, utilities, regulation/compliance, technology, employee turnover/promotion, currency exchange data and inflation data. The computer-based system is also configured for receiving buyer-specific input criteria reflecting all, or at least key, parameters associated with a particular contract.

The various inputs are then evaluated against the original economic balance defined by the initial contract terms to produce a Global Services Cost Index (GSCI) that can be used to adjust or rebalance the current financial terms in order to reestablish, with reasonable accuracy, the original economic balance between the buyer and the vendor or within a Global In-house Center (GIC). Given the dynamic nature of the labor situation and other parameters that can affect the economic balance, the terms of the original agreement can provide for a GSCI adjustment in response to certain triggering events and/or on a defined schedule as warranted by the particular situation.

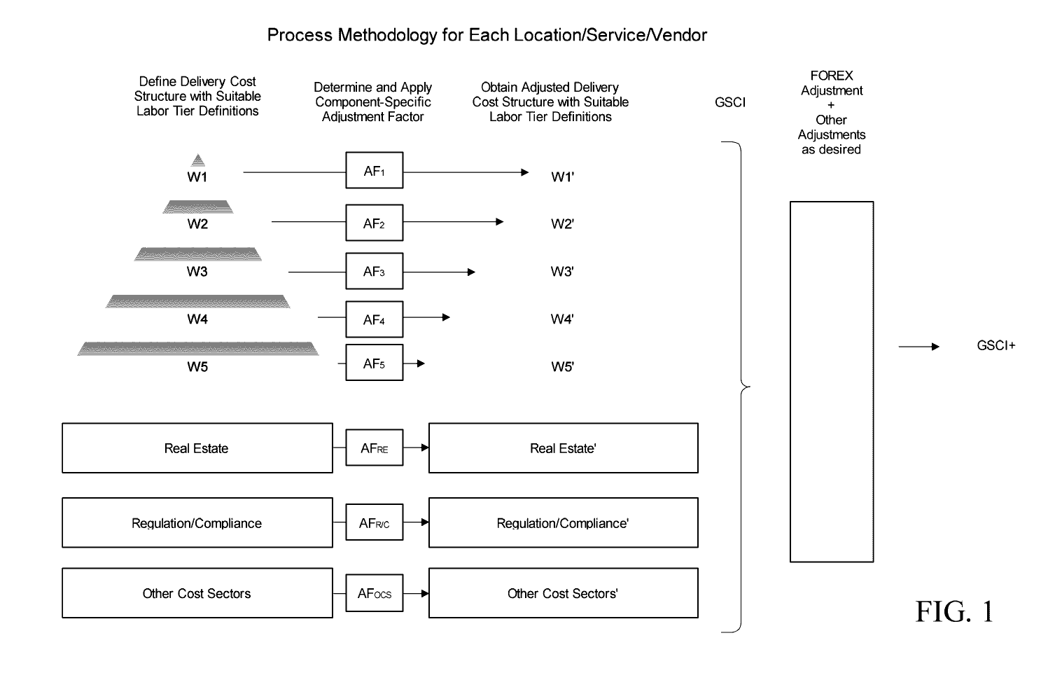

As illustrated in FIG. 1, the system includes one or more databases containing financial data information relating to a plurality of locations and vendors at which outsourcing contracts have or may be serviced. The system will also include at least one database that includes contract specific data relating to the outsourcing contract in question specifically with regard to the format or implementation of the wage and/or skill pyramid associated with servicing that contract.

In a first embodiment of the invention, the system retrieves financial data information for Location A from the database and contract specific data relating to a particular outsourcing contract. Using this information, the system then generates an adjusted labor pyramid that reflects the current economic conditions at Location A, the GSCI.

This adjusted labor pyramid will then typically be subject to additional adjustments based on current or trending foreign exchange rates relating to the currencies utilized in the contract. Other adjustments may be made in light of other economic and/or business conditions that may affect the ability of the vendor to adequately service the contract at location A. With these secondary adjustments, the updated labor pyramid can be subjected to one or more further adjustments to arrive at a net price adjustment factor, or GSCI+. For those contracts that are serviced in multiple locations and/or through multiple vendors, the process would be repeated for each location and/or vendor to produce, at the end, a cumulative cost index for a company's global operations.

A second embodiment of the invention is utilized in those instances in which the financial information available for Location A is determined to be insufficient or inadequate in some way. In such a case, the system will access corresponding information maintained in the same or other databases that relate to one or more similar operations and/or vendors at other locations for which adequate information is available. The information associated with, for example, Location B and/or Location C (and/or other locations) can then be used to “triangulate” the financial information to obtain a reasonable estimate of the financial conditions existing at Location A. This triangulated financial information for Location A can then be used as in the first embodiment to calculate the GSCI in the manner detailed above.

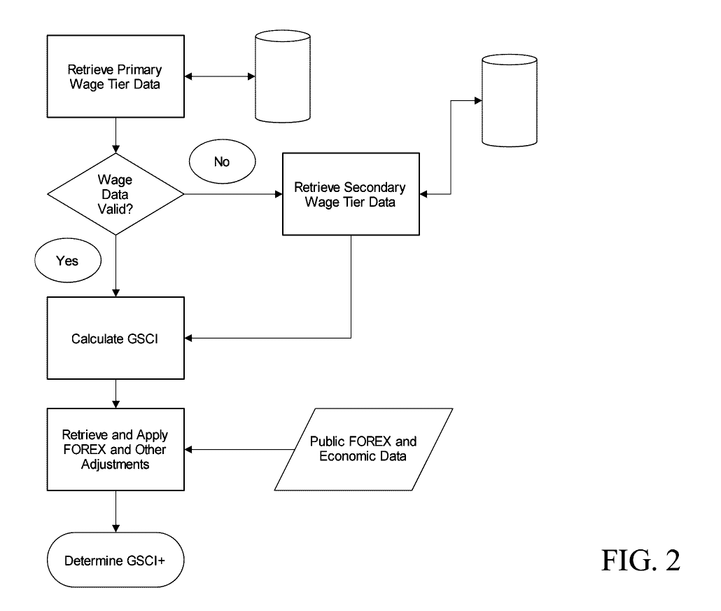

A basic flowchart encompassing both the first and second embodiments is illustrated in FIG. 2. As detailed above, focused financial data associated with the target location is retrieved from one or more databases. The retrieved information is then evaluated to ensure that it is suitable for application to the particular wage tier pyramid utilized in the subject contract.

If it is determined that the data is not sufficient in some respect, additional data from corresponding locations and/or industries is retrieved in order to generate triangulated financial data for the target location in order to improve the confidence of the resulting projection.

If it is determined that the data is sufficient in, for example, terms of volume, history and timing, the process proceeds by incorporating the contract specific information and the general financial information, e.g., foreign-exchange rates, inflation information and possibly other relevant public data, to generate the GSCI that can be used for reestablishing the economic balance that previously existed between the buyer and the vendor in light of the changed labor, financial and/or economic environment.

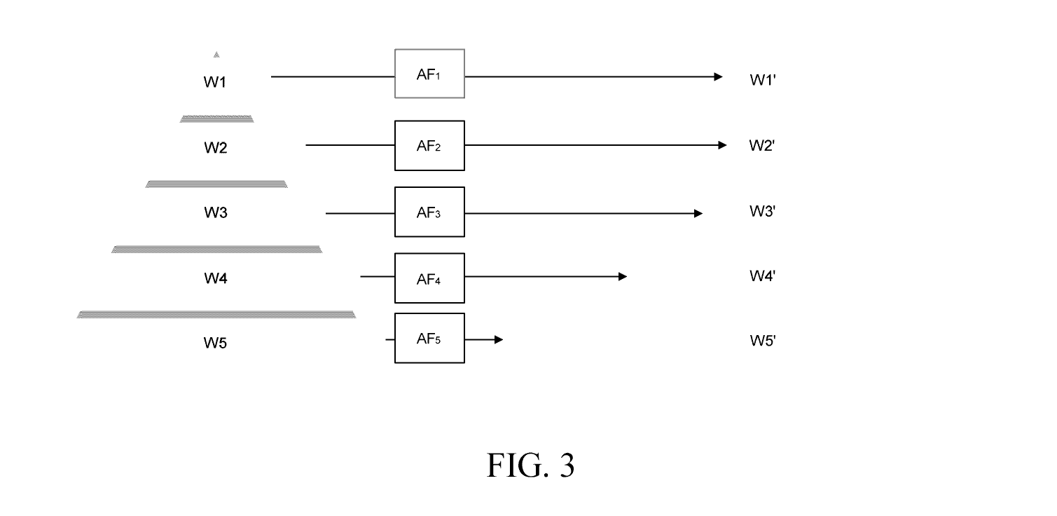

While the disclosed methods and system are useful for adjusting the financial obligations in an outsourcing contract even when there is no significant realignment of the labor pyramid utilized in servicing the contract, they can be of even greater value in those situations in which there is substantial realignment of the labor pyramid during the life of the contract. Assuming, for instance, that the labor pyramid illustrated on the left side of FIG. 3 was initially utilized for servicing a contract and included wage tiers W1-W5. If, at some future point, changing conditions and/or functions warranted an adjustment to achieve the labor pyramid illustrated on the right side of FIG. 3, with wage tiers W1′-W5′ reflecting reduced mid-level management and increased lower tier labor numbers, in order to service the contract, the altered ratios of the relative skill levels incorporated in the respective labor/wage tier pyramids would be expected to significantly alter the total salary costs associated with servicing the contract.

But by applying the labor pyramid methodology detailed above, even these substantial changes can be easily accounted for during generation of the GSCI. While the illustrated labor pyramids include only five levels, the method detailed above is quite flexible and can readily accommodate greater or lesser numbers of levels as necessary to allow for sufficiently accurate modeling of the labor distribution necessary to service any particular contract or business venture at any given time.

As will be appreciated by those skilled in the art, the disclosed methods and systems may be applied for evaluating and, when necessary, adjusting the relative financial obligations of the participants in a wide range of multijurisdictional business agreements. These business agreements may include, for example, conventional outsourcing contracts, operation of global in-house centers (GICs), operation of foreign subsidiaries, operation of joint ventures and/or the operation of foreign partners.

The methods detailed above and illustrated in FIGS. 1-3 can be performed on, for example, any suitable combinations of systems, subsystems, servers, workstations, PCs, laptop computers, PDAs, and/or wireless devices capable of performing, or being configured to perform, the processes of the exemplary methods. The devices, subsystems, and systems used to practice the exemplary methods can be configured to communicate with each other using any suitable protocol and can be implemented using one or more programmed computer systems or devices.

One or more interface mechanisms can be used in practicing the exemplary embodiments as described above and illustrated in FIGS. 1-3, including, for example, internet access, telecommunications in any suitable form (e.g., voice, modem, and the like), wireless communications media, and the like. For example, the employed communications networks can include one or more wireless communications networks, cellular communications networks, 3G communications networks, Public Switched Telephone Network (PSTNs), Packet Data Networks (PDNs), the internet, intranets, and combinations thereof.

The systems detailed above and illustrated in FIGS. 1-3 can be configured in, for example, any suitable combinations of systems, subsystems, servers, workstations, PCs, laptop computers, PDAs, and/or wireless devices capable of performing, or being configured to perform, the processes of the exemplary methods. The devices, subsystems, and systems used to configure the exemplary systems can be arranged to communicate with each other using any suitable protocol and can be implemented using one or more programmed computer systems or devices.

One or more interface mechanisms can be used in connecting and accessing the exemplary systems as described above and illustrated in FIGS. 1-3, including, for example, internet access, telecommunications in any suitable form (e.g., voice, modem, and the like), wireless communications media, and the like. For example, the employed communications networks can include one or more wireless communications networks, cellular communications networks, 3G communications networks, Public Switched Telephone Network (PSTNs), Packet Data Networks (PDNs), the internet, intranets, and combinations thereof.

It will be understood by those skilled in the art that the exemplary embodiments illustrated in FIGS. 1-3 and described above are for exemplary purposes and that many variations of the specific hardware and/or software used to implement the exemplary methods and systems are possible.

To implement such variations as well as other variations, a single computer system can be programmed to perform the special purpose functions of one or more of the devices and subsystems of the exemplary embodiments of FIGS. 1-3. Conversely, two or more programmed computer systems or devices can be utilized for performing the function(s) attributed to any one of the devices, subsystems, and systems of the exemplary embodiments of FIGS. 1-3. Accordingly, principles and advantages of distributed processing, such as redundancy, replication, and the like, also can be implemented, as desired, to increase the robustness and performance the devices, subsystems and systems used for practicing the invention.

The devices and subsystems used to practice the methods and configure the systems of the exemplary embodiments of FIGS. 1-3 can be configured to store information relating to various processes described herein. This information can be stored in one or more memories including, for example, hard disks, optical disks, magneto-optical disks, RAM, SRAM or other suitable memory devices and combinations thereof. One or more databases contained within or accessible by the devices and subsystems of the exemplary embodiments can store the information used to implement the exemplary methods of the present invention. The databases can be organized using data structures (e.g., records, tables, arrays, fields, graphs, trees, lists, and other suitable data structures and combinations thereof) resident in one or more memories or storage devices listed herein. The processes described with respect to the exemplary methods can include appropriate data structures for storing data collected and/or generated by the processes of the devices and subsystems in one or more databases thereof.

All or a portion of the devices and subsystems necessary for executing the exemplary methods can be conveniently implemented using one or more general purpose computer systems, microprocessors, digital signal processors, micro-controllers, or other suitable devices, that have been programmed or are programmable by those skilled in the computer and software arts. Appropriate software can be readily prepared by programmers of ordinary skill based on the teachings of the exemplary embodiments and the devices and subsystems of the necessary for implementing the exemplary embodiments can be achieved through the preparation of application-specific integrated circuits (ASIC) or by interconnecting one or more appropriate network(s) of conventional component circuits. Accordingly, the exemplary embodiments are not limited to any specific combination of hardware circuitry and/or software.

Stored on any one or on a combination of computer readable media, the exemplary embodiments of the present invention can include software for controlling the devices and subsystems of the exemplary embodiments, for driving the devices and subsystems of the exemplary embodiments, for enabling the devices and subsystems of the exemplary embodiments to interact with a human user, and the like.

Such software may include, but is not limited to, device drivers, firmware, operating systems, development tools, applications software, and other suitable tools. Such computer readable media may also include the computer program product of an embodiment of the present invention for performing all or a portion (if distributed processing is utilized) of the processing performed in implementing the exemplary embodiments. Computer code devices of for executing the functions inherent in the exemplary embodiments of the present invention can include any suitable interpretable or executable code mechanism, including, but not limited to, scripts, interpretable programs, dynamic link libraries (DLLs), Java classes and applets, complete executable programs, Common Object Request Broker Architecture (CORBA) objects.

As noted above, the systems for practicing the exemplary methods may include computer readable media or memories for holding 1) instructions programmed according to the teachings of the present invention and 2) data structures, tables, records, and/or other data described herein. The computer readable media can include any suitable medium that participates in providing instructions to a processor for execution including, for example, non-volatile media, volatile media, and transmission media. Common forms of computer-readable media include, for example, floppy disks, hard disks, magnetic tape, other suitable magnetic media, a CD-ROM, CDRW, DVD, any other suitable optical media, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

Although the present invention has been described herein in considerable detail with reference to particular exemplary embodiments, certain modifications or alterations may be apparent to those skilled in the art, without departing from the scope of the invention. The exemplary embodiments are meant to be illustrative, not limiting the scope of the invention, which is defined by the following claims.

We claim:

1. A computer-implemented method for making adjusting a cost structure associated with an outsourcing agreement comprising:
retrieving a base cost structure from a machine readable memory, a base cost structure wherein the base cost structure includes a plurality of cost tiers;
obtaining economic data for a plurality of variables associated with the cost tiers;
calculating an adjustment factor specific to each cost tier;
applying the adjustment factors to obtain an adjusted delivery cost structure for each cost tier; and
using the adjusted delivery cost structures to calculate a global services cost index (GSCI).

2. A computer-implemented method according to claim 1, further comprising:
applying a secondary adjustment to the global services cost index to calculate a net price adjustment factor (GSCI+).

3. A computer-implemented method according to claim 1, wherein:
the secondary adjustment is a function of foreign currency exchange rates.

4. A computer-implemented method according to claim 1, wherein:
the cost tiers include a plurality of labor tiers.

5. A computer-implemented method according to claim 4, wherein:
an additional cost tier includes a cost tier selected from a group consisting of real estate costs, regulatory costs, compliance costs, training cost, health care costs, shipping costs, material costs, and combinations thereof.

6. A computer-implemented method according to claim 1, wherein:
at least a portion of the economic data is specific to a location in which the outsourcing agreement is being fulfilled.

7. A computer-implemented method according to claim 6, wherein:
at least a portion of the economic data is collected from a plurality of alternative locations in order to approximate economic data specific to the location in which the outsourcing agreement is being fulfilled.

8. A non-transitory computer-readable memory or data storage means encoded with data representing a computer program for making adjusting a cost structure associated with an outsourcing agreement, the computer-readable memory or data storage means causing the computer to perform the acts of:
providing a processor operatively coupled to a communication network;
providing one or more databases operatively coupled to the processor and accessible through the communication network;
coupling an interface to the processor for receiving input;
establishing a machine-readable memory in at least one database, wherein the memory includes a multidimensional financial reference set comprising data specific to each cost tier and a base cost structure;
calculating a cost tier specific adjustment factor from the multidimensional financial reference set for each cost tier;
applying the cost tier specific adjustment factors to the base cost structure to obtain an adjusted delivery cost structure for each cost tier; and
determining a global services cost index for the outsourcing agreement.

9. A computer-implemented method for periodically adjusting a cost structure associated with an outsourcing agreement comprising:
retrieving a base cost structure from a machine readable memory, a base cost structure wherein the base cost structure includes a plurality of cost tiers;
obtaining economic data for a plurality of variables associated with the cost tiers;
calculating an adjustment factor specific to each cost tier from the economic data;
determining an accuracy factor for at least one cost tier;
applying the adjustment factors and the accuracy factor to obtain an adjusted delivery cost structure for each cost tier; and
using the adjusted delivery cost structures to calculate a ranged global services cost index (rGSCI).

10. The computer-implemented method for adjusting a cost structure according to claim 9, wherein:
a plurality of the cost tiers have associated accuracy factors.

11. The computer-implemented method for adjusting a cost structure according to claim 10, wherein:
at least two of the associated accuracy factors have different values.

12. The computer-implemented method for adjusting a cost structure according to claim 9, wherein:
the accuracy factor is expressed as a range of values.

13. The computer-implemented method for adjusting a cost structure according to claim 12, wherein:
the range of values result from the application of a plurality of economic forecasting models to the economic data.

14. The computer-implemented method for adjusting a cost structure according to claim 12, wherein:
the range of values result from uncertainty with regard a factor selected from a group consisting of political climate, regulatory landscape, weather, environmental factors, regional civil instability, local civil instability and combinations thereof.

15. The computer-implemented method for adjusting a cost structure according to claim 12, wherein:
the range of values result from the application of an economic forecasting model and uncertainty with regard to at least one factor selected from a group consisting of political climate, regulatory landscape, weather, environmental factors, regional civil instability, local civil instability and combinations thereof.
